(19) United States
(12) Patent Application Publication
(10) Pub. No.: US 2025/0097578 A1
(43) Pub. Date: Mar. 20, 2025

(54) ELECTROMAGNETIC DRIVING MECHANISM, CAMERA MODULE AND ELECTRONIC DEVICE

(71) Applicant: MEMS DRIVE (NANJING) CO., LTD, NANJING (CN), NANJING (CN)

(72) Inventors: QIJUN HU, NANJING (CN); ANNIE ZUOYA QU, NANJING (CN); GUIQIN WANG, NANJING (CN)

(21) Appl. No.: 18/953,400

(22) Filed: Nov. 20, 2024

Related U.S. Application Data
(63) Continuation of application No. PCT/CN2023/129283, filed on Nov. 2, 2023.

(30) Foreign Application Priority Data
Dec. 19, 2022 (CN) 202211636039.3

(51) Int. Cl. H04N 23/68

(52) U.S. Cl. CPC H04N 23/687; H04N 23/6812

(57) ABSTRACT

An electromagnetic driving mechanism, a camera module, and an electronic device are provided. The electromagnetic driving mechanism includes a first metal plate, a second metal plate, at least one coil, at least one magnetic element, and at least one actuating assembly. The second metal plate is disposed opposite to the first metal plate. The at least one coil and the at least one magnetic element are stacked between the first metal plate and the second metal plate. The at least one actuating assembly is disposed on the first metal plate and connected to the at least one coil, and the at least one actuating assembly is configured to support the imager.

### TECHNICAL FIELD

The present disclosure relates to a technical field of actuators, and in particular to an electromagnetic driving mechanism, a camera module, and an electronic device.

### BACKGROUND

A voice coil motor (VCM) is a device configured to convert electrical energy into mechanical energy and capable of enabling both linear motion and motion within a limited angular range. The VCM achieves regular motion through interaction between magnetic poles of a magnetic field generated by a permanent magnet and a magnetic field generated by an energized coil conductor. The VCM enables image stabilization of a camera of a portable photographing device.

In the prior art, the VCM typically includes a ball. During an actuating process, the ball causes non-linear friction forces, resulting in increase of the non-linear friction forces during an image stabilization process, thereby directly affecting image stabilization performance and also complicating precise motion control.

### SUMMARY

A technical solution addressed by the present disclosure is to provide an electromagnetic driving mechanism, a camera module, and an electronic device with a novel structure to achieve precise motion control and improve image stabilization performance.

In order to achieve above technical purposes, in a first aspect, the present disclosure provides the electromagnetic driving mechanism, including a first metal plate, a second metal plate, at least one coil, at least one magnetic element, and at least one actuating assembly. The second metal plate is disposed opposite to the first metal plate. The at least one coil and the at least one magnetic element are stacked between the first metal plate and the second metal plate. The at least one actuating assembly is disposed on the first metal plate and connected to the at least one coil, and the at least one actuating assembly is configured to support the imager. The at least one coil is driven by an Ampere force to move with respect to the at least one magnetic element within a magnetic field of the at least one magnetic element after being energized, thereby driving the at least one actuating assembly to deform to drive the imager to move.

In some embodiments, the at least one actuating assembly includes a motion control component and a flexible electrical connector. The motion control component is connected to the at least one coil and the first metal plate, the motion control component is configured to deform and move within a plane parallel to the first metal plate and is limited from moving out of the plane. The flexible electrical connector is connected to the motion control component. The at least one coil is fixedly connected to two ends of the motion control component. The at least one coil drives the motion control component to at least partially deform to drive the imager to move.

In some embodiments, the flexible electrical connector includes a wire portion main body, a first connecting portion, and a second connecting portion. The first connecting portion is connected to a first side of the wire portion main body and is connected to the motion control component. The second connecting portion is connected a second side of the wire portion main body and is disposed opposite to the first connecting portion.

In some embodiments, the motion control component includes two first moving portions, a second moving portion, at least one elastic portion, and a fixing portion. The two first moving portions are respectively disposed at two ends of the wire portion main body in a length direction of the wire portion main body. The second moving portion is connected to the first connecting portion and is configured to support the imager. The at least one elastic portion is disposed at a periphery of the second moving portion and is connected to the first connecting portion. The fixing portion is disposed on the at least one elastic portion and is fixedly connected to the first metal plate. The two first moving portions, the second moving portion, and the imager move along with the at least one coil, and the at least one elastic portion is configured to elastically deform.

In some embodiments, the first connecting portion is electrically connected to the imager via wire bonding.

In some embodiments, the first metal plate defines at least one first slot, the at least one first slot penetrates through the first metal plate in a thickness direction of the first metal plate.

In some embodiments, the electromagnetic driving mechanism further includes a circuit board. The circuit board is disposed opposite to the first metal plate and is disposed at one side of the first metal plate away from the second metal plate. The second connecting portion is electrically connected to the circuit board via the wire bonding.

In some embodiments, the first metal plate further defines at least one second slot, the at least one second slot is defined closer to an edge of the first metal plate than the at least one first slot. The second connecting portion is electrically connected to the circuit board through the at least one second slot via the wire bonding.

In some embodiments, the at least one coil spans across the flexible electrical connector and is disposed on the two first moving portions.

In some embodiments, the at least one elastic portion includes a first sub-elastic portion and a second sub-elastic portion, the first sub-elastic portion is connected to the second-sub elastic portion.

In some embodiments, the first sub-elastic portion is bent and connected to the second sub-elastic portion.

In some embodiments, at least four actuating assemblies are provided, the at least four actuating assemblies include at least four motion control components, a plurality of magnetic elements are provided and are divided into at least two groups of magnetic elements, and at least two coils are provided.

In some embodiments, each of the at least two groups of magnetic elements is disposed corresponding to a corresponding one of the at least two coils. Each of the at least two groups of magnetic elements includes two magnets disposed side by side or a single magnet.

In some embodiments, first projections of each two magnets onto a plane parallel to a plane of the first metal plate are side by side, and second projections of each two magnets onto a plane perpendicular to the plane of the first metal plate completely overlap.

In some embodiments, on the plane parallel to the plane of the first metal plate, a first projection of each of the at least two coils falls within a first projection of a corresponding one of the at least two groups of magnetic elements. On the plane perpendicular to the plane of the first metal plate, a second projection of each of the at least two coils is parallel to a second projection of the corresponding one of the at least two groups of magnetic elements.

In some embodiments, on the plane parallel to the plane of the first metal plate, a center point of the first projection of each of the at least two coils overlaps a center point of the first projection of the corresponding one of the at least two groups of magnetic elements.

In some embodiments, four motion control components are provided, the four motion control components are disposed on the first metal plate, the four motion control components are centered on the imager and are respectively disposed at opposite sides of the imager.

In some embodiments, the four motion control components are integrally formed.

In some embodiments, four groups of magnetic elements are provided, the four groups of magnetic elements are disposed at a periphery of the four motion control components at intervals along a circumferential direction of the four motion control components.

In some embodiments, four coils are provided, the four coils are respectively connected to the four motion control components.

In some embodiments, the motion control component and the flexible electrical connector are integrally formed.

In some embodiments, a material for preparing the motion control component and/or the flexible electrical connector include a silicon wafer.

In some embodiments, the at least one magnetic element is connected to the second metal plate, the second metal plate, the at least one magnetic element, and the at least one coil are stacked in sequence; or, the at least one magnetic element is connected to the first metal plate, the second metal plate, the at least one coil, and the at least one magnetic element are stacked in sequence.

In a second aspect, the present disclosure provides the camera module including a lens assembly configured to collect light, the electromagnetic driving mechanism as foregoing, a gyroscope configured to detect vibration of the lens assembly, and the imager disposed on the at least one actuating assembly of the electromagnetic driving mechanism. In response to the vibration of the lens assembly, the at least one actuating assembly drives the imager to move in a direction opposite to a vibration direction of the lens assembly.

In a third aspect, the present disclosure provides the electronic device, including a device main body and the camera module as foregoing. The camera module is disposed on the device main body.

According to a structure of the electromagnetic driving mechanism provided in embodiments of the present disclosure, the at least one coil, the at least one magnetic element, and the at least one actuating assembly cooperate to drive the imager to move to achieve image stabilization performance. Specifically, the at least one coil moves with respect to the at least one magnetic element within the magnetic field of the at least one magnetic element after being energized, thereby driving the at least one actuating assembly to deform to drive the imager supported by the at least one actuating assembly to move, in this way, displacement caused by moving the imager counteracts shaking caused by vibration to achieve the image stabilization performance.

Furthermore, distinguished from a ball driving mode in the prior art, the electromagnetic driving mechanism of the present disclosure drives the at least one actuating assembly to deform to drive the imager to move, thereby avoiding non-linear friction forces caused during an image stabilization process, in this way, motion control difficulty is effectively reduced, motion control precision and the image stabilization performance are further improved. Moreover, the electromagnetic driving mechanism of the present disclosure is simple and compact in structure and convenient for assembly, thereby enabling mass production.

### BRIEF DESCRIPTION OF DRAWINGS

Embodiments are described with reference to accompanying drawings. The accompanying drawings of the present disclosure are only used to describe the embodiments to show a purpose of the present disclosure. Other embodiments are readily apparent to those who skilled in the art from following description without departing from principles of the present disclosure.

FIG. 1 is a three-dimensional exploded schematic diagram of an electromagnetic driving mechanism according to one embodiment of the present disclosure.

FIG. 2 is a partial structural schematic diagram of the electromagnetic driving mechanism after being assembled according to one embodiment of the present disclosure shown in FIG. 1.

FIG. 3 is a partial cross-sectional structural schematic diagram of the electromagnetic driving mechanism after being assembled according to one embodiment of the present disclosure shown in FIG. 1.

FIG. 4 is a structural schematic diagram of a first metal plate of the electromagnetic driving mechanism according to one embodiment of the present disclosure shown in FIG. 1.

FIG. 5 is a structural schematic diagram of a magnetic field layout of the electromagnetic driving mechanism according to one embodiment of the present disclosure shown in FIG. 1.

FIG. 6 is a structural schematic diagram of another magnetic field layout of the electromagnetic driving mechanism according to one embodiment of the present disclosure shown in FIG. 1.

FIG. 7 is a structural schematic diagram of a frame and a second metal plate of the electromagnetic driving mechanism according to one embodiment of the present disclosure shown in FIG. 1.

FIG. 8 is a structural schematic diagram of the electromagnetic driving mechanism according to one embodiment of the present disclosure.

FIG. 9 is a structural schematic diagram of the electromagnetic driving mechanism according to another embodiment of the present disclosure.

FIG. 10 is a structural schematic diagram of an actuating assembly of the electromagnetic driving mechanism according to one embodiment of the present disclosure.

FIG. 11 is a structural schematic diagram of the actuating assembly of the electromagnetic driving mechanism supporting an imager according to one embodiment of the present disclosure shown in FIG. 1.

FIG. 12 is a partial structural schematic diagram of a first connecting portion of a flexible electrical connector according to one embodiment of the present disclosure shown in FIG. 10.

FIG. 13 is a partial structural schematic diagram of a second connecting portion of a flexible electrical connector according to one embodiment of the present disclosure shown in FIG. 10.

FIG. 14 is a partial structural schematic diagram of the flexible electrical connector and a motion control component according to one embodiment of the present disclosure shown in FIG. 10.

FIG. 15 is a structural schematic diagram of a camera module according to one embodiment of the present disclosure.

FIG. 16 is a structural schematic diagram of an electronic device according to one embodiment of the present disclosure.

Reference numerals in the drawings: 100. electromagnetic driving mechanism; 10. first metal plate; 11. first slot; 12. second slot; 20. square plate; 31. first coil; 32. second coil; 33. third coil; 34. fourth coil; 41. first group of magnetic elements; 42. second group of magnetic elements; 43. third group of magnetic elements; 44. fourth group of magnetic elements; 51. first actuating assembly; 52. second actuating assembly; 53. third actuating assembly; 54. fourth actuating assembly; 511. first motion control component; 521. second motion control component; 531. third motion control component; 541. fourth motion control component; 5111a, 5111b. first moving portion; 5112. second moving portion; 5113. fixing portion; 5114, 5115. elastic portion; 5114a. first sub-elastic portion; 5114b. second sub-elastic portion; 5115a. third sub-elastic portion; 5115b. fourth sub-elastic portion; 512. first flexible electrical connector; 522. second flexible electrical connector; 532. third flexible electrical connector; 5121. wire portion main body; 5122. first connecting portion; 5123. second connecting portion; 60. circuit board; 70. frame; 701. through hole; 200. camera module; 210. lens assembly; 220. imager; 300. electronic device; 310. device main body.

### DETAILED DESCRIPTION OF EMBODIMENTS

Following clearly and completely describes technical solutions in embodiments of the present disclosure with reference to accompanying drawings in the embodiments of the present disclosure. It may be understood that specific embodiments described herein are only used to explain the present disclosure, rather than to limit the present disclosure. In addition, it should be noted that, for ease of description, only some but not all of structures related to the present disclosure are shown in the accompanying drawings. All other embodiments obtained by those who skilled in the art based on the embodiments of the present disclosure without creative efforts shall fall within a protection scope of the present disclosure.

Terms “first”, “second”, etc. in the present disclosure are used to distinguish between different objects, but are not used to describe a specific order. In addition, terms “include” and “have” and any variations thereof are intended to cover non-exclusive inclusion. For example, a process, method, system, product, or device that includes a series of steps or units is not limited to the listed steps or units, but optionally further includes steps or units that are not listed, or optionally further includes other steps or units inherent to these processes, methods, products, or devices.

Reference herein to “embodiment” means that a particular feature, structure, or characteristic described in connection with the embodiments may be included in at least one embodiment of the present disclosure. Appearances of the “embodiment” in various places in the specification are not necessarily all referring to the same embodiment, nor are separate or alternative embodiments mutually exclusive with other embodiments. It is explicitly and implicitly understood by those who skilled in the art that the embodiments described herein may be combined with other embodiments.

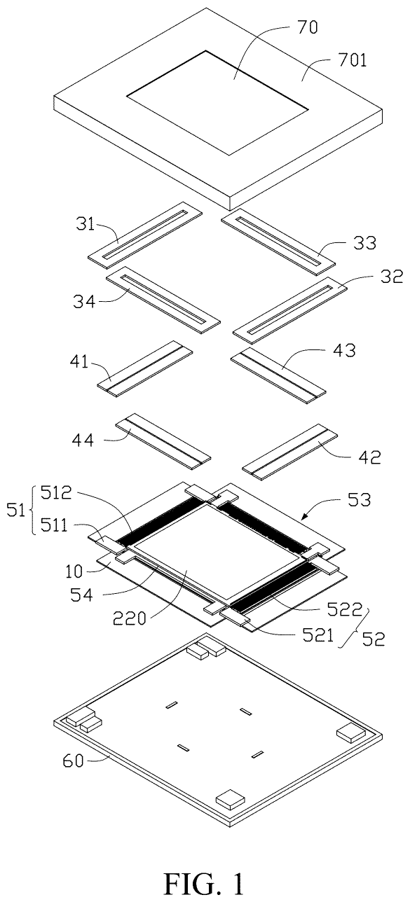

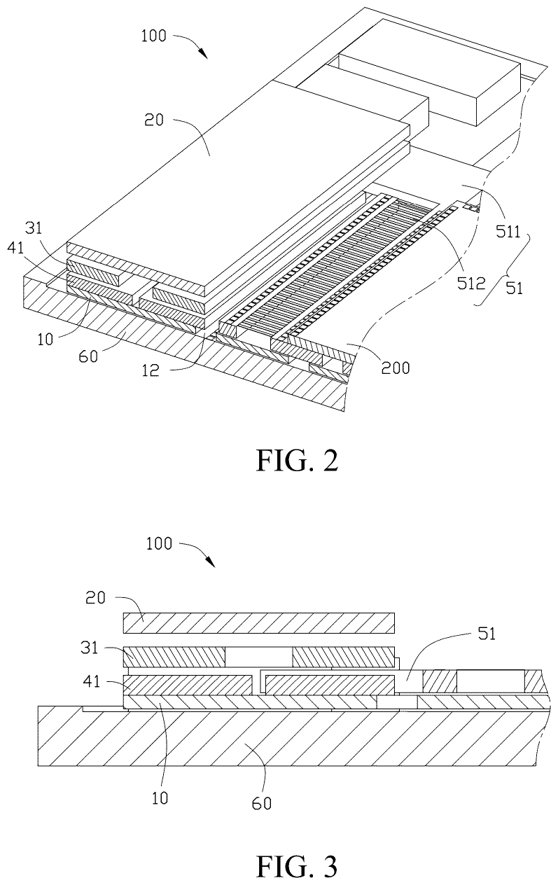

Please refer to FIGS. 1-3, FIG. 1 is a three-dimensional exploded schematic diagram of an electromagnetic driving mechanism according to one embodiment of the present disclosure, FIG. 2 is a partial structural schematic diagram of the electromagnetic driving mechanism after being assembled according to one embodiment of the present disclosure shown in FIG. 1, and FIG. 3 is a partial cross-sectional structural schematic diagram of the electromagnetic driving mechanism after being assembled according to one embodiment of the present disclosure shown in FIG. 1. The electromagnetic driving mechanism 100 is applied to a camera module 200 (as shown in FIG. 15.). Specifically, the camera module 200 includes an imager 220. As shown in FIG. 1, the electromagnetic driving mechanism 100 includes a first metal plate 10, a second metal plate, at least one coil, at least one magnetic element, and at least one actuating assembly. The second metal plate is disposed opposite to the first metal plate 10. The at least one coil and the at least one magnetic element are stacked between the first metal plate 10 and the second metal plate. The at least one actuating assembly is disposed on the first metal plate 10 and connected to the at least one coil, and the at least one actuating assembly is configured to support the imager 220. The at least one coil is driven by an Ampere force to move with respect to the at least one magnetic element within a magnetic field of the at least one magnetic element after being energized, thereby driving the at least one actuating assembly to deform to drive the imager 220 to move.

In some embodiments, the electromagnetic driving mechanism 100 further includes a circuit board 60. The circuit board 60 is disposed opposite to the first metal plate 10 and is disposed at one side of the first metal plate 10 away from the second metal plate.

In some embodiments, the electromagnetic driving mechanism 100 further includes a frame 70. The frame 70 is fastened to the circuit board 60. The second metal plate is disposed at one side of the frame 70 facing the first metal plate 10.

Please refer to FIGS. 1-4, FIG. 4 is a structural schematic diagram of the first metal plate of the electromagnetic driving mechanism according to one embodiment of the present disclosure shown in FIG. 1. Specifically, as shown in FIGS. 1-4, the first metal plate 10 is configured to support the at least one actuating assembly, the at least one magnetic element, the at least one coil, and the second metal plate.

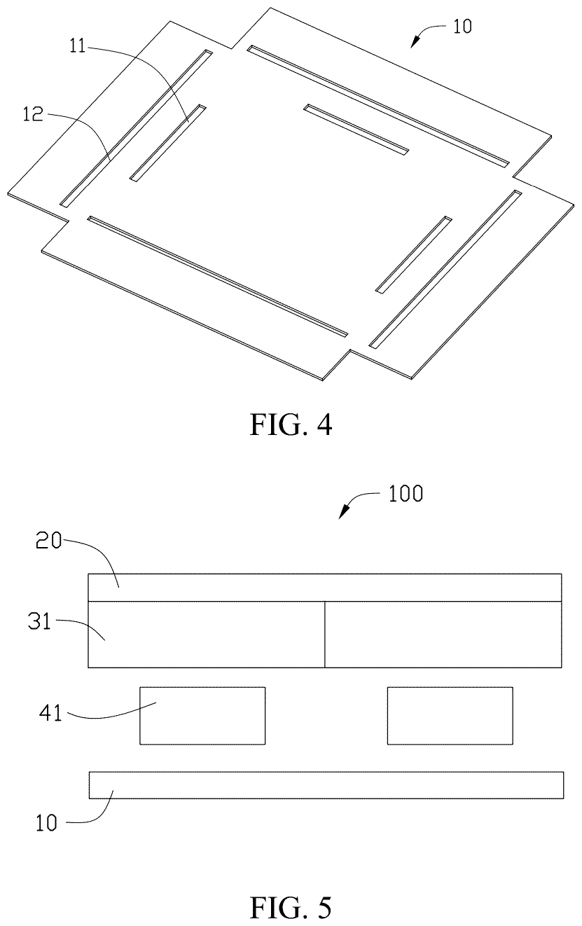

As shown in FIG. 4, in some embodiments, the first metal plate 10 defines at least one first slot 11 and at least one second slot 12, the at least one first slot 11 penetrates through the first metal plate 10 in a thickness direction of the first metal plate 10. The at least one first slot 11 is defined corresponding to the at least one actuating assembly for holding at least a part of the at least one actuating assembly using vacuum suction during assembly. Furthermore, the at least one second slot 12 is defined closer to an edge of the first metal plate 10 than the at least one first slot 11. The at least one second slot 12 is configured to separate a magnetic field. Moreover, during a process of electrically connecting the circuit board 60 to the at least one actuating assembly, the at least one actuating assembly is electrically connected to the circuit board 60 through the at least one second slot 12 via the wire bonding. In one embodiment, the first metal plate 10 is an iron plate. In some embodiments, the at least one first slot 11 is also referred as a vacuum suction slot, and the at least one second slot 12 is also referred as a separation slot.

In some embodiments, three first slots 11 and four second slots 12 are provided, certainly, the number of the at least one first slot 11 and the number of the at least one second slot 12 may also be determined according to specific design requirements, for example, four first slots 11 and four second slots 12 are provided, one first slot 11 is provided, or two first slots 11 are provided, etc.

As shown in FIG. 4, when the four second slots 12 are provided, the four second slots are divided into two groups of second slots 12, two second slots 12 in each of the two groups of second slots 12 are oppositely disposed, that is, the two second slots in each of the two groups of second slots 12 are close to corresponding edges of the first metal plate 10 and are respectively defined at two opposite sides of the first metal plate 10. Correspondingly, when three second slots 12 are provided, each first slot 11 is substantially parallel to a corresponding one of the three second slots 12, and each of the three second slots is defined closer to a corresponding edge of the first metal plate 10 than a corresponding first slot 11.

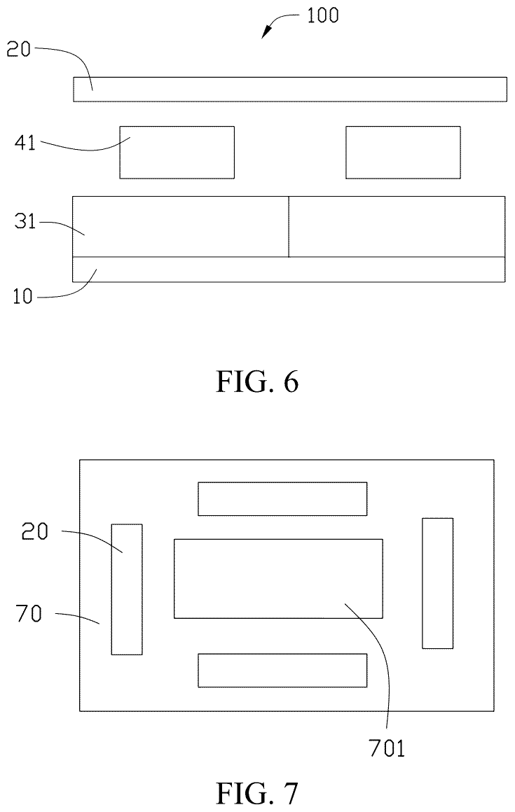

Please refer to FIGS. 5-6, FIG. 5 is a structural schematic diagram of a magnetic field layout of the electromagnetic driving mechanism according to one embodiment of the present disclosure shown in FIG. 1, and FIG. 6 is a structural schematic diagram of another magnetic field layout of the electromagnetic driving mechanism according to one embodiment of the present disclosure shown in FIG. 1.

As shown in FIGS. 5-6, in some embodiments, the first metal plate 10 further has functions of electromagnetic shielding and magnetic field guidance. Since the at least one coil and the at least one magnetic element are stacked between the first metal plate 10 and the second metal plate, a magnetic field generated by the at least one magnetic element forms a closed channel between the first metal plate 10 and the second metal plate. Such a magnetic field layout not only maximizes magnetic force output of the at least one coil, but also reduces magnetic field leakage. Therefore, in a structural design of the electromagnetic driving mechanism 100 of the embodiments of the present disclosure, the magnetic field generated by the at least one magnetic element disposed between the first metal plate 10 and the second metal plate is mainly distributed between the first metal plate 10 and the second metal plate, so that a magnetic flux density between the first metal plate 10 and the second metal plate is relatively high, and a magnetic flux density outside the first metal plate 10 and the second metal plate is relatively low, that is, there is less magnetic field leakage. In this way, a magnetic field in which the at least one coil is stacked with the at least one magnetic element is stronger, and a magnetic field of other areas (other than an area where the at least one coil is located) is weaker.

Please refer to FIGS. 2-3 and 7, FIG. 7 is a structural schematic diagram of the frame and the second metal plate of the electromagnetic driving mechanism according to one embodiment of the present disclosure shown in FIG. 1. As shown in FIGS. 2-3, the second metal plate includes square plates 20, the square plates 20 are shaped corresponding to shapes of the at least one coil and the at least one magnetic element. Specifically, the square plates 20 are disposed at one side of the frame 70 facing the first metal plate 10, so that the magnetic field generated by the at least one magnetic element forms the closed channel between the second metal plate and the first metal plate 10.

In some embodiments, as shown in FIG. 7, the square plates 20 are respectively disposed on the one side of the frame 70 facing the first metal plate 10, that is, the second metal plate is configured as a separated structure, for example, the square plates 20 are respectively disposed the frame 70 by coating epoxy resin (or coating various adhesives, coating bonding materials, and/or using bonding methods) on a surface of the frame 70 and then respectively bonding or molding the square plates 20 onto the surface of the frame 70 coated with the epoxy resin.

In some other embodiments, the square plates 20 are also integrally formed, that is, the second metal plate is integrally formed and is bonded or molded onto the frame 70.

As shown in FIGS. 1, 2, and 7, the frame 70 is square, a through hole 701 is defined on the frame 70, and the electromagnetic driving mechanism 100 is connected to functional elements of the camera module 200 through the through hole 701, for example, the electromagnetic driving mechanism 100 is connected to a lens through the through hole 701. It can be understood that, according to specific application requirements, the frame 70 may also be configured in other shapes, such as a circle or a hexagon.

In some embodiments, when second metal plate including the square plates 20 is configured as the separated structure, four square plates 20 are provided, and the foursquare plates 20 are disposed at a periphery of the through hole 701 at intervals along a circumferential direction of the through hole 701.

In some other embodiments, when the second metal plate including the square plates 20 is configured as an integrally formed structure, the second metal plate surrounds the periphery of the through hole 701.

Please refer to FIGS. 1-4, the at least one magnetic element is disposed corresponding to the at least one coil, and the at least one magnetic element and the at least one coil are disposed between the first metal plate 10 and the second metal plate. After the at least one coil is energized, the at least one coil generates the Ampere force within the magnetic field generated by the at least one magnetic element and is driven by the Ampere force to move with respect to the at least one magnetic element in a direction parallel to the Ampere force. Furthermore, the at least one actuating assembly connected to the at least one coil is also deformed to drive the imager 220 supported on the at least one actuating assembly to move, that is, the imager 220 moves in a distance. When the at least one coil is de-energized, the Ampere force disappears, the at least one actuating assembly being deformed returns to an original state, and the imager 220 also returns to an initial position, that is, the at least one actuating assembly and the imager 220 are reset.

In some embodiments, by changing a magnitude and a direction of current of the at least one coil, a magnitude and a direction of the Ampere force are further changed, so as to change displacement of the imager 220, in this way, displacement changes during moving the imager 220 counteracts shaking caused by vibration to achieve mage stabilization performance.

As shown in FIG. 1, in one embodiment, a first projection of the at least one coil onto a plane parallel to a plane of the first metal plate 10 is annular, and a second projection of the at least one coil onto a plane perpendicular to the plane of the first metal plate 10 is strip-shaped.

In some embodiments, the at least one magnetic element is a single magnet. In some other embodiments, a plurality of magnetic elements are provided to divided into a group of magnetic elements including two magnets. Specifically, the two magnets are disposed side by side, and the two magnets are attached with each other or separated from each other. Furthermore, magnetic pole directions of the two magnets disposed side by side are opposite. For example, a first side of a first one of the two magnets is a north pole of the first one of the two magnets and a second side of the first one of the two magnets is a south pole of the first one of the two magnets, then a first side of a second one of the two magnets close to the first side of the first one of the two magnets is a south pole of the second one of the two magnets, and a second side of the second one of the two magnets close to the second side of the first one of the two magnets is a north pole of the second one of the two magnets, and vice versa.

Specifically, in a structure of the electromagnetic driving mechanism shown in FIG. 5, a first side of a first one of the two magnets close to the second metal plate is a north pole of the first one of the two magnets, a second side of the first one of the two magnets away from the second metal plate is a south pole of the first one of the two magnets, a first side of a second one of the two magnets close to the second metal plate is a south pole of the second one of the two magnets, and a second side of the second one of the two magnets away from the second metal plate is a north pole of the second one of the two magnets.

In some embodiments, first projections of the two magnets disposed side by side onto the plane parallel to the plane of the first metal plate 10 are side by side, second projections of the two magnets disposed side by side onto the plane perpendicular to the plane of the first metal plate 10 completely overlap.

The single magnet is disposed corresponding to the at least one coil, or the group of magnetic elements including the two magnets is disposed corresponding to the at least one coil. On the plane parallel to the plane of the first metal plate 10, a first projection of the at least one coil falls within a first projection of the group of magnetic elements. On the plane perpendicular to the plane of the first metal plate 10, the second projection of the at least one coil is parallel to a second projection of the group of magnetic elements.

Furthermore, a stacking sequence of the group of magnetic elements and the at least one coil is interchangable.

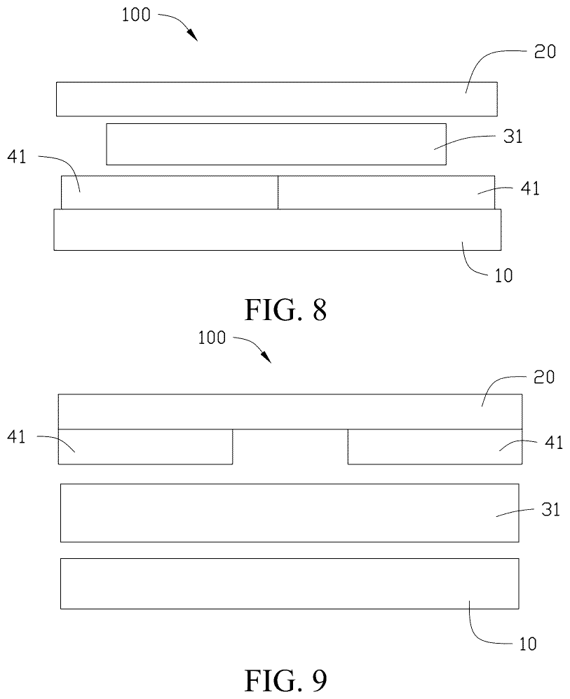

Please refer to FIG. 8, FIG. 8 is a structural schematic diagram of the electromagnetic driving mechanism according to one embodiment of the present disclosure. As shown in FIG. 8, in some embodiments, the group of magnetic elements is connected to the first metal plate 10, the second metal plate, the at least one coil, and the group of magnetic elements are stacked in sequence. Specifically, the epoxy resin (or coating the various adhesives, coating the bonding materials, and/or using the bonding methods) is coated on a surface of the first metal plate 10 facing the second metal plate, and the group of magnetic elements is connected to the surface of the first metal plate 10 coated with the epoxy resin, for example, the epoxy resin is coated on an area of the first metal plate 10 between the at least one second slot 12 and a corresponding edge of the first metal plate 10. In this way, the group of magnetic elements are directly disposed on the first metal plate 10, which is easy to process.

Please refer to FIG. 9, FIG. 9 is a structural schematic diagram of the electromagnetic driving mechanism according to another embodiment of the present disclosure. As shown in FIG. 9, in some other embodiments, the group of magnetic elements is connected to the second metal plate, the second metal plate, the group of magnetic elements, and the at least one coil are stacked in sequence. Specifically, the epoxy resin (or coating the various adhesives, coating the bonding materials, and/or using the bonding methods) is coated on a surface of the second metal plate facing the first metal plat 10e, and the group of magnetic elements is connected to the surface of the second metal plate coated with the epoxy resin. In this way, the electromagnetic driving mechanism 100 is compact in structure, thereby reducing an overall size thereof.

It can be understood that, the embodiment of the electromagnetic driving mechanism 100 shown in FIG. 8 and the embodiment of the electromagnetic driving mechanism 100 shown in FIG. 9 have basically the same process of driving the at least one actuating assembly to deform and are mainly different in assembling processes, a stacking manner of the at least one coil and the at least one magnetic element is different, and a specific stacking manner of the at least one coil and the at least one magnetic element may be selected according to actual needs. Following content of the present disclosure is described with the at least one coil and the at least one magnetic element as shown in FIG. 8.

In some embodiments, the plurality of magnetic elements are provided and divided into two groups of magnetic elements, the two groups of magnetic elements include a first group of magnetic elements 41 and a second group of magnetic elements 42 or include a third group of magnetic elements 43 and a fourth group of magnetic elements 44. Specifically, the first group of magnetic elements 41 and the second group of magnetic elements 42 are respectively disposed at two ends of the at least one second slot 12, or, the third group of magnetic elements 43 and the fourth group of magnetic elements 44 are respectively disposed at the two ends of the at least one second slot 12.

Correspondingly, two coils are provided, the two coils include a first coil 31 and a second coil 32, the first coil 31 and the second coil 32 are oppositely disposed, or the two coils include a third coil 33 and a fourth coil 34, the third coil 33 and the fourth coil 34 are oppositely disposed. Each of the two coils is disposed corresponding to a corresponding one of the two groups of magnetic elements. Specifically, the first coil 31 and the first group of magnetic elements 41 are stacked and the second coil 32 and the second group of magnetic elements 42 are stacked, or, the third coil 33 and the third group of magnetic elements 43 are stacked and the fourth coil 34 and the fourth group of magnetic elements 44 are stacked.

Furthermore, two actuating assemblies are provided, the two actuating assemblies includes a first actuating assembly 51 connected to the first coil 31 and a second actuating assembly 52 connected to the second coil 32, or, the two actuating assemblies includes a third actuating assembly 53 connected to the third coil 33 and a fourth actuating assembly 54 connected to the fourth coil 34. Correspondingly, the first actuating assembly 51 and the second actuating assembly 52 are oppositely disposed. The third actuating assembly 53 and the fourth actuating assembly 54 are oppositely disposed. The imager 220 is supported on the first actuating assembly 51 and the second actuating assembly 52, or, the imager 220 is supported on the third actuating assembly 53 and the fourth actuating assembly 54.

In some embodiments, the plurality of magnetic elements are divided into four groups of magnetic elements including the first group of magnetic elements 41, the second group of magnetic elements 42, a third group of magnetic elements 43, and a fourth group of magnetic elements 44. Specifically, each two groups of the four groups of magnetic elements are oppositely disposed. Correspondingly, four coils are provided, the four coils include the first coil 31, the second coil 32, the third coil 33, and the fourth coil 34. Each of the four coils is disposed corresponding to a corresponding one of the four groups of magnetic elements. Specifically, the four coils are divided into two groups of coils, each of the two groups of coils include two coils oppositely disposed.

Furthermore, four actuating assemblies are correspondingly provided, the four actuating assemblies include the first actuating assembly 51 connected to the first coil 31, the second actuating assembly 52 connected to the second coil 32, the third actuating assembly 53 connected to the third coil 33, and the fourth actuating assembly 54 connected to the fourth coil 34. The imager 220 is supported on the first actuating assembly 51, the second actuating assembly 52, the third actuating assembly 53, and the fourth actuating assembly 54.

It should be noted that the first group of magnetic elements 41, the second group of magnetic elements 42, the third group of magnetic elements 43, and the fourth group of magnetic elements 44 share the same structural design, that is, each of the four group of magnetic elements include a single magnet or two magnets separated from each other and is disposed corresponding to a corresponding one of the four coils. Similarly, the first coil 31, the second coil 32, the third coil 33, and the fourth coil 34 share the same structural design, the first actuating assembly 51, the second actuating assembly 52, the third actuating assembly 53, and the fourth actuating assembly 54 share the same structural design. The embodiments of the present disclosure specifically describe a structure of one group of the four groups of magnetic elements, or one of the four coils, or one of the four actuating assemblies, and structures of other three groups of the four groups of magnetic elements, or other three of the four coils, or other three of the four actuating assemblies may all refer to related content, and details are not described herein again.

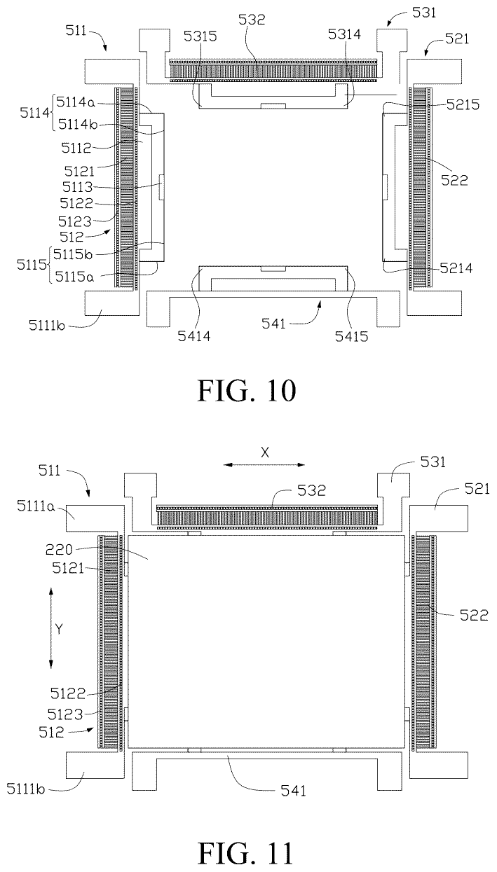

Please refer to FIGS. 10-11, FIG. 10 is a structural schematic diagram of the at least one actuating assembly of the electromagnetic driving mechanism according to one embodiment of the present disclosure, and FIG. 11 is a structural schematic diagram of the at least one actuating assembly of the electromagnetic driving mechanism supporting the imager according to one embodiment of the present disclosure shown in FIG. 1. As shown in FIGS. 10-11, the at least one actuating assembly includes a motion control component and a flexible electrical connector connected to the motion control component. The motion control component is connected to the at least one coil and the first metal plate 10, the motion control component is configured to deform and move within a plane parallel to the first metal plate 10 and is limited from moving out of the plane. Furthermore, the at least one coil is fixedly connected to two ends of the motion control component. Furthermore, the motion control component is configured to support the imager 220. Specifically, the at least one coil is driven by the Ampere force to move with respect to the at least one magnetic element within the magnetic field of the at least one magnetic element after being energized, thereby driving the motion control component to at least partially deform to drive the imager 220 to move. When the at least one coil is de-energized, the Ampere force disappears, the motion control component being at least partially deformed returns to an original state, and the imager 220 also returns to the initial position, that is, the motion control component and the imager 220 are reset.

Please further refer to FIGS. 1-5 and 10, specifically, as shown in FIG. 10, the flexible electrical connector includes a wire portion main body 5121 composed of a plurality of wires, and the wire portion main body 5121 is substantially strip-shaped.

Furthermore, the flexible electrical connector further includes a first connecting portion 5122 and a second connecting portion 5123. The first connecting portion 5122 is connected to a first side of the wire portion main body 5121 and is connected to the motion control component. The second connecting portion 5123 is connected a second side of the wire portion main body 5121 and is disposed opposite to the first connecting portion 5122.

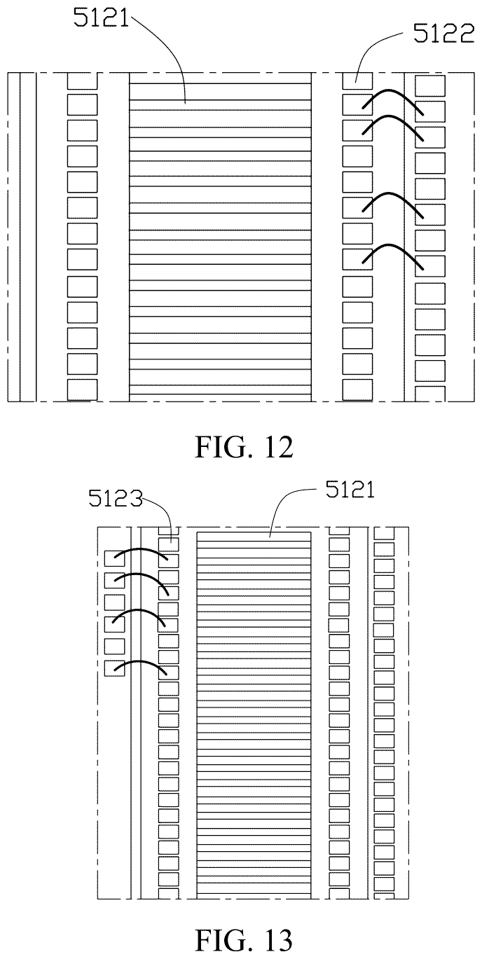

In some embodiments, the first connecting portion 5122 includes a first pin. As shown in FIG. 12, FIG. 12 is a partial structural schematic diagram of the first connecting portion of the flexible electrical connector according to one embodiment of the present disclosure shown in FIG. 10. As shown in FIG. 12, the first connecting portion 5122 is electrically connected to the imager 220 via the wire bonding. When the at least one coil is energized, the at least one coil drives the motion control component to at least partially deform to drive the imager 220 to move, and the first connecting portion 5122 further moves along with the imager 220. When the at least one coil is de-energized, the Ampere force disappears, the motion control component being at least partially deformed returns to the original state, and the imager 220 also returns to the initial position, at this time, the first connecting portion 5122 is reset accordingly. Therefore, the first connecting portion 5122 is also referred to as a movable connecting portion.

In some embodiments, the second connecting portion 5123 includes a second pin. As shown in FIG. 13, FIG. 13 is a partial structural schematic diagram of the second connecting portion of the flexible electrical connector according to one embodiment of the present disclosure shown in FIG. 10. As shown in FIG. 13, the second connecting portion 5123 is electrically connected to the circuit board 60 through the at least one second slot 12 of the first metal plate 10 via the wire bonding. Since the second connecting portion 5123 is fixedly connected to the circuit board 60 during a process of driving the imager 220 by the motion control component to move or reset. Therefore, the second connecting portion 5123 is also referred to as a fixing connecting portion.

In some embodiments, a material for preparing the flexible electrical connector include a silicon wafer. Specifically, the flexible electrical connector is manufactured by preparing processes of the silicon wafer, such as photolithography and etching. Therefore, the first connecting portion 5122 and the second connecting portion 5123 are also be referred to as two E-bars (electrical connection terminals) of the flexible electrical connector. In the embodiments, a plurality of actuating assemblies are provided, the plurality of actuating assemblies include a plurality of flexible electrical connector, although there are three flexible electrical connectors including a first flexible electrical connector 512, a second flexible electrical connector 522, and a third flexible electrical connector 531 provided in the embodiments shown in the drawings, the present disclosure is not limited thereto, and the number of the flexible electrical connector is determined according to a structural design of the imager 220, for example, according to an electrical connection structure of the imager 220, the number of the flexible electrical connector is also set as one, two, or four, which is not specifically limited in the present disclosure.

It should be noted that the first flexible electrical connector 512, the second flexible electrical connector 522, and the third flexible electrical connector 532 share the same structural design, and specifically refer to a structure of the flexible electrical connector in the embodiments of the present disclosure.

The flexible electrical connector in the embodiments play an electrical connection role in the electromagnetic driving mechanism 100. Compared with the circuit board 60, the flexible electrical connector is more compact in structure and occupies a small space. Therefore, to some extent, the flexible electrical connector is provided to further reduce the overall size of the electromagnetic driving mechanism 100.

Please refer to FIGS. 9-10 and 1-4, the at least one coil drives the motion control component to at least partially deform to drive the imager 220 to move. Specifically, a material for preparing the motion control component include the silicon wafer, the motion control component with high precision is manufactured by the preparing processes of the silicon wafer, such as the photolithography and the etching, and a ratio of out-of-plane stiffness to in-plane stiffness is relatively high, that is, the motion control component is configured to deform and move within the plane parallel to the first metal plate and is limited from moving out of the plane. In this way, the motion control component in the embodiment is substantially not interfered by out-of-plane motion. Since the motion control component is attached to the at least one coil, the motion control component is deformed along with the at least one coil being energized, meanwhile, the motion control component is further reset along with the at least one coil being de-energized. Furthermore, since the material for preparing the motion control component includes the silicon wafer, the motion control component may be referred to as a silicon spring.

In some embodiments, the motion control component and the flexible electrical connector are integrally formed through the preparing processes of the silicon wafer, such as the photolithography and the etching. That is, the at least one actuating assembly being integrally formed is simple and compact in structure.

In some embodiments, the epoxy resin (or coating various adhesives, and/or coating bonding materials) is coated on the surface of the first metal plate 10 facing the second metal plate, for example, the epoxy resin is coated on an area of the first metal plate 10 between the at least one second slot 12 and the at least one first slot 11 and an area of the first metal plate 10 from the at least one first slot 11 to a central position of the first metal plate 10, and then the motion control component and the flexible electrical connector are connected to the surface of the first metal plate 10 coated with the epoxy resin.

Specifically, the motion control component includes two first moving portions 5111a, 5111b, a second moving portion 5112, at least one elastic portion 5114, and a fixing portion 5113. The two first moving portions 5111a, 5111b are respectively disposed at two ends of the wire portion main body 5121 in a length direction of the wire portion main body 5121. The second moving portion 5112 is connected to the first connecting portion 5122 and is configured to support the imager 220. The at least one elastic portion 5114 is disposed at a periphery of the second moving portion 5112 and is connected to the first connecting portion 5122. The fixing portion 5113 is disposed on the at least one elastic portion 5114 and is fixedly connected to the first metal plate 10. Specifically, the at least one coil is driven by the Ampere force to move with respect to the at least one magnetic element within the magnetic field of the at least one magnetic element after being energized, the two first moving portions 5111a, 5111b, the second moving portion 5112, and the imager 220 move along with the at least one coil, and the at least one elastic portion 5114 is configured to elastically deform along with the two first moving portions 5111a, 5111b, the second moving portion 5112, and the imager 220. When the at least one coil is de-energized, the Ampere force disappears, the at least one elastic portion 5114 being elastically deformed returns to an original state, and the imager 220 also returns to the initial position, that is, the at least one elastic portion 5114 and the imager 220 are reset.

In some embodiments, the two first moving portions 5111a, 5111b are square. The at least one coil spans across the flexible electrical connector and is disposed on the two first moving portions 5111a, 5111b. In some embodiments, the at least one spans across the flexible electrical connector to be respectively connected to the two first moving portions 5111a, 5111b. Specifically, the epoxy resin (or coating the various adhesives, coating the bonding materials, and/or using the bonding methods) is further coated on top surfaces of the two first moving portions 5111a, 5111b, and the at least one coil is then respectively connected to the top surfaces of the two first moving portions 5111a, 5111b coated with the epoxy resin. In one embodiment, the two first moving portions 5111a, 5111b are integrally formed.

In some embodiments, one side of the second connecting portion 5112 is connected to the first connecting portion 5122 and the second connecting portion 5112 is strip-shaped. Specifically, the epoxy resin (or coating the various adhesives, coating the bonding materials, and/or using the bonding methods) is further coated on a top surface of the second moving portion 5112, and one end of the imager 220 is then connected to the top surface of the second moving portion 5112 coated with the epoxy resin.

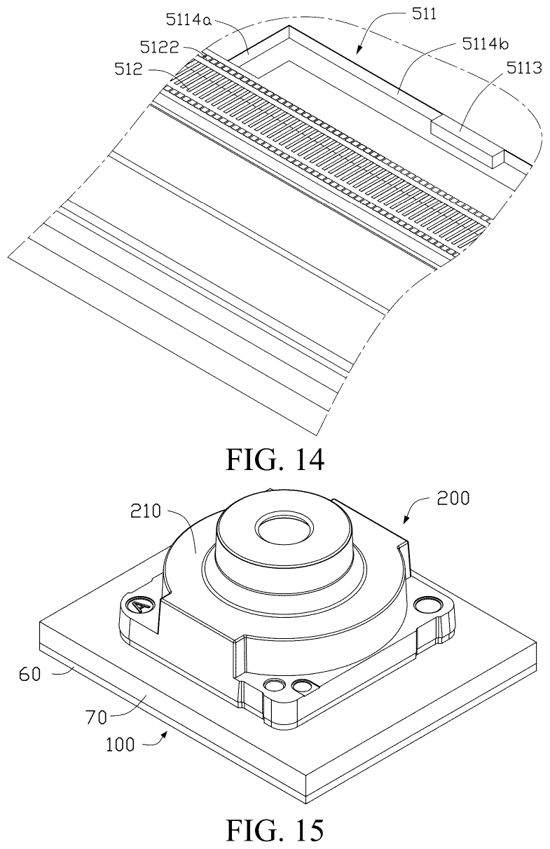

Please refer to FIG. 14, FIG. 14 is a partial structural schematic diagram of the flexible electrical connector and the motion control component according to one embodiment of the present disclosure shown in FIG. 10. As shown in FIG. 14, the at least one elastic portion 5114 is configured as a high aspect ratio structure, for example, an elongated beam structure with a high aspect ratio. The at least one elastic portion 5114 with the high aspect ratio structure enables a ratio of out-of-plane stiffness to in-plane stiffness of the at least one elastic portion 5114 to be relatively high, that is, the at least one elastic portion 5114 is configured to deform and move within the plane parallel to the first metal plate 10 and is limited from moving out of the plane, thereby achieving a motion control effect.

Specifically, in one embodiment, an elastic portion 5114 is provided, the elastic portion 5114 includes a first sub-elastic portion 5114a and a second sub-elastic portion 5114b, the first sub-elastic portion 5114a is connected to the second-sub elastic portion 5114b. In some embodiments, the first sub-elastic portion 5114a is bent and connected to the second sub-elastic portion 5114b. Specifically, a first end of the first sub-elastic portion 5114a is connected to a first end of the second sub-elastic portion 5114b, a second end of the first sub-elastic portion 5114a is connected to the first connecting portion 5122, and a second end of the second sub-elastic portion 5114b is connected to the fixing portion 5113.

In some embodiments, the first sub-elastic portion 5114a and the second sub-elastic portion 5114b are substantially perpendicular to each other to form an L shape.

In some embodiments, in a structural design of the motion control component, two elastic portions 5114, 5115 are provided, for example, the elastic portion 5114 and an elastic portion 5115 are provided. Similarly, a structural design of the elastic portion 5115 is substantially the same as a structure of the elastic portion 5114. For example, the elastic portion 5115 includes a third sub-elastic portion 5115a and a fourth sub-elastic portion 5115b, the third sub-elastic portion 5115a connected to the fourth sub-elastic portion 5115b. Specifically, the third sub-elastic portion 5115a is bent and connected to the fourth sub-elastic portion 5115b, a first end of the third sub-elastic portion 5115a is connected to the first connecting portion 5122, a second end of the third sub-elastic portion 5115a is connected to a first end of the fourth sub-elastic portion 5115b, and a second end of the fourth sub-elastic portion 5115b is connected to the fixing portion 5113.

In some embodiments, the fixing portion 5113 is disposed at a connection between the second sub-elastic portion 5114b and the fourth sub-elastic portion 5115b. Compared with an overall size of the second moving portion 5112, an overall size of the fixing portion 5113 is small. When the motion control component is connected to the first metal plate 10 through coating the epoxy resin (or coating the various adhesives, coating the bonding materials, and/or using the bonding methods), the fixing portion 5113 is bonded to the surface of the first metal plate 10 as a fixed anchor point of the motion control component. In this way, the fixing portion 5113 is also be referred to as an anchoring portion.

In some embodiments, the two first moving portions 5111a, 5111b, the second moving portion 5112, the two elastic portions 5114, 5115, and the fixing portion 5113 of the motor control component are respectively manufactured by the preparing processes of the silicon wafer, such as the photolithography and the etching. After manufacturing, the two first moving portions 5111a, 5111b, the second moving portion 5112, the two elastic portions 5114, 5115, and the fixing portion 5113 are assembled to obtain the motion control component. In some other embodiments, the two first moving portions 5111a, 5111b, the second moving portion 5112, the two elastic portions 5114, 5115, and the fixing portion 5113 of the motor control component are integrally formed through the preparing processes of the silicon wafer, such as the photolithography and the etching.

As shown in FIG. 10, the four actuating assemblies are provided, correspondingly, four motion control components are provided, and three flexible electrical connectors are further provided according to the electrical connection structure of the imager 220. However, the present disclosure is not limited thereto, the number of the motion control component is determined according to specific application requirements, for example, one or two or more motion control components are provided.

When the four motion control components are provided, the four motion control components include a first motion control component 511 connected to the first coil 31, a second motion control component 521 connected to the second coil 32, a third motion control component 531 connected to the third coil 33, and a fourth motion control component connected to the fourth coil 34. Specifically, each pair of the four motion control components is oppositely disposed.

It should be noted that the first motion control component 511, the second motion control component 521, the third motion control component 531, and the fourth motion control component 541 share the same structural design, and specifically refer to a structure of the motion control component in the embodiments of the present disclosure.

In some embodiments, the four motion control components are disposed on the first metal plate 10, the four motion control components are centered on the imager 220 and are respectively disposed at opposite sides of the image 220.

In some embodiments, the four groups of magnetic elements are provided, the four groups of magnetic elements are disposed at a periphery of the four motion control components at intervals along a circumferential direction of the four motion control components.

When assembling the electromagnetic driving mechanism 100, the motion control component and/or the flexible electrical connector are connected to the surface of the first metal plate 10 facing the second metal plate, then the two first moving portions 5111a, 5111b are secured through the at least one first slot 11 of the first metal plate 10. Furthermore, the imager 220 is connected to the second moving portion 5112 of the motion control component, and the flexible electrical connector is electrically connected to the imager 220 via the wire bonding. The first metal plate 10 connected with the motion control component, the flexible electrical connector, and the imager 200 are fixedly connected to the circuit board 60, and the second connecting portion 5123 of the flexible electrical connector is electrically connected to the circuit board 60 via the wire bonding. Then, the at least one magnetic element is connected to the first metal plate 10, and the at least one coil spans across the flexible electrical connector to respectively connected to the two first moving portions 5111a, 5111b, at this time, the at least one coil and the at least one magnetic element are stacked. Furthermore, the frame 70 bonded to the second metal plate is fastened to the circuit board 60. So far, the electromagnetic driving mechanism 100 is completely assembled.

It should be noted that connection between the above assembly process is achieved through coating the epoxy resin (or coating the various adhesives, coating the bonding materials, and/or using the bonding methods).

In some embodiments, the plurality of magnetic elements are provided and divided into the two groups of magnetic elements, the two groups of magnetic elements include the first group of magnetic elements 41 and the second group of magnetic elements 42 or include the third group of magnetic elements 43 and the fourth group of magnetic elements 44. Correspondingly, the two coils are provided, the two coils include the first coil 31 and the second coil 32, the first coil 31 and the second coil 32 are oppositely disposed, or the two coils include the third coil 33 and the fourth coil 34, the third coil 33 and the fourth coil 34 are oppositely disposed. Each of the two coils is disposed corresponding to the corresponding one of the two groups of magnetic elements. Two motion control components are further provided, the two motion control components include the first motion control component 511 and the second motion control component 521, the first motion control component 511 and the second motion control component 521 are oppositely disposed, or the two motion control components include the third motion control component 531 and the fourth motion control component 541, the third motion control component 531 and the fourth motion control component 541 are oppositely disposed. The imager 220 is supported on the first motion control component 511 and the second motion control component 521 or is supported on the third motion control component 531 and the fourth motion control component 541.

In some embodiments, after the first coil 31 and the second coil 32 are energized, the first coil 31 and the second coil 32 generate a first Ampere force along a first direction X (as shown in FIG. 11) in a magnetic field generated by the first group of magnetic elements 41 and the second group of magnetic elements 42. The first coil 31 and the second coil 32 are driven by the first Ampere force to move with respect to the first group of magnetic elements 41 and the second group of magnetic elements 42 in a direction parallel to the first direction X. In this way, a corresponding elastic portion 5114 and/or a corresponding elastic portion 5115 of the first motion control component 511 and a corresponding elastic portion 5214 and/or a corresponding elastic portion 5215 of the second motion control component 521 are deformed along with moving of the first coil 31 and the second coil 32 to drive the imager 220 supported on the first motion control component 511 and the second motion control component 521 to move in the direction parallel to the first direction X.

Furthermore, by changing a magnitude and a direction of current of the first coil 31 and/or the second coil 32, a magnitude and a direction of the first Ampere force are further changed, so as to change displacement of the imager 220 along the direction parallel to the first direction X, in this way, displacement changes during moving the imager 220 along the direction parallel to the first direction X counteracts the shaking caused by the vibration to achieve the image stabilization performance.

In some other embodiments, after the third coil 33 and the fourth coil 34 are energized, the third coil 33 and the fourth coil 34 generate a second Ampere force along a second direction Y (as shown in FIG. 11) in a magnetic field generated by the third group of magnetic elements 43 and the fourth group of magnetic elements 44. The third coil 33 and the fourth coil 34 are driven by the second Ampere force to move with respect to the third group of magnetic elements 43 and the fourth group of magnetic elements 44 in a direction parallel to the second direction Y. In this way, a corresponding elastic portion 5314 and/or a corresponding elastic portion 5315 of the third motion control component 531 and a corresponding elastic portion 5414 and/or a corresponding elastic portion 5415 of the fourth motion control component 541 are deformed along with moving of the third coil 33 and the fourth coil 34 to drive the imager 220 supported on the third motion control component 531 and the fourth motion control component 541 to move in the direction parallel to the second direction Y.

Furthermore, by changing a magnitude and a direction of current of the third coil 33 and/or the fourth coil 34, a magnitude and a direction of the second Ampere force are further changed, so as to change displacement of the imager 220 along the direction parallel to the second direction Y, in this way, displacement changes during moving the imager 220 along the direction parallel to the second direction Y counteracts the shaking caused by the vibration to achieve the image stabilization performance.

In one embodiment, on the plane parallel to the plane of the first metal plate 10, the first direction X is substantially perpendicular to the second direction Y.

In some embodiments, the plurality of magnetic elements are divided into the four groups of magnetic elements including the first group of magnetic elements 41, the second group of magnetic elements 42, the third group of magnetic elements 43, and the fourth group of magnetic elements 44. Correspondingly, the four coils are provided, the four coils include the first coil 31, the second coil 32, the third coil 33, and the fourth coil 34. Each of the four coils is disposed corresponding to a corresponding one of the four groups of magnetic elements. Furthermore, four motion control components are provided, the four motion control components include the first motion control component 511, the second motion control component 521, the third motion control component 531, the fourth motion control component 541. The imager 220 is supported on the first motion control component 511, the second motion control component 521, the third motion control component 531, the fourth motion control component 541.

When the first coil 31, the second coil 32, the third coil 33 and the fourth coil 34 are simultaneously energized, the first coil 31 and the second coil 32 generate the first Ampere force along the first direction X in the magnetic field generated by the first group of magnetic elements 41 and the second group of magnetic elements 42, and meanwhile, the third coil 33 and the fourth coil 34 generate the second Ampere force along the second direction Y in the magnetic field generated by the third group of magnetic elements 43 and the fourth group of magnetic elements 44. In this way, the first coil 31 and the second coil 32 drive the corresponding elastic portion 5114 and/or the corresponding elastic portion 5115 of the first motion control component 511 and the corresponding elastic portion 5214 and/or the corresponding elastic portion 5215 of the second motion control component 521 to correspondingly deform, meanwhile, the third coil 33 and the fourth coil 34 drive the corresponding elastic portion 5314 and/or the corresponding elastic portion 5315 of the third motion control component 531 and the corresponding elastic portion 5414 and/or the corresponding elastic portion 5415 of the fourth motion control component 541 to deform. In this way, the first motion control component 511 and the second motion control component 521 drives the imager 220 to move along the direction parallel to the first direction X, and meanwhile, the third motion control component 531 and the fourth motion control component 541 further drive the imager 220 to move along the direction parallel to the second direction Y. Therefore, the imager 220 is simultaneously driven by the four motion control components to respectively generates a first displacement along the first direction X and a second displacement along the second direction Y at the same time, so that the imager 220 is capable moving to any position within the plane parallel to the first metal plate 10.

Furthermore, by changing a magnitude and a direction of current of at least one of the first coil 31, the second coil 32, the third coil 33 and the fourth coil 34, the magnitude and the direction of the first Ampere force and the magnitude and the direction of the second Ampere force are further changed, so as to change the first displacement of the imager 220 and the second displacement of the imager 220, in this way, changes of the first displacement and the second displacement during moving the imager 220 counteract the shaking caused by the vibration to achieve the image stabilization performance.

According to a structure of the electromagnetic driving mechanism 100 provided in embodiments of the present disclosure, the at least one coil, the at least one magnetic element, and the at least one actuating assembly cooperate to drive the imager 220 to move to counteract the shaking caused by the vibration, so as to achieve the image stabilization performance. Specifically, the at least one coil moves with respect to the at least one magnetic element within the magnetic field of the at least one magnetic element after being energized, thereby driving the at least one actuating assembly to deform to drive the imager 220 supported by the at least one actuating assembly to move, in this way, displacement caused by moving the imager 220 counteracts the shaking caused by the vibration to achieve the image stabilization performance.

Furthermore, when the four actuating assemblies are provided, the imager 220 is capable of moving in two different directions at the same time, so that the imager 220 is capable of moving to any position within the plane parallel to the first metal plate 10 to counteract the shaking caused by the vibration, thereby further improving the image stabilization performance.

Furthermore, distinguished from a ball driving mode in the prior art, the electromagnetic driving mechanism 100 of the present disclosure drives the corresponding elastic portion 5114 and/or the corresponding elastic portion 5515 of the motion control component to deform to drive the imager 220 to move, thereby avoiding non-linear friction forces, in this way, motion control difficulty is effectively reduced, motion control precision and image stabilization precision are further improved.

Meanwhile, since a volume of a ball of a voice coil motor (VCM) in the prior art is relatively large, an overall size of the VCM is large. Moreover, when assembling the VCM, the ball requests relatively high assembly precision, so that assembly difficulty of the VCM is large. In addition, coils in the VCM generally require an additional flexible circuit board for electrical connection, thereby increasing complexity and cost in assembling the VCM. However, the electromagnetic driving mechanism 100 of the present disclosure is provided with the at least one actuating assembly including the flexible electrical connector and the motion control component to replace the ball and the additional flexible circuit board, the flexible electrical connector and the motion control component are manufactured by the preparing processes of the silicon wafer, such as the photolithography and the etching, so that an overall size of the electromagnetic driving mechanism 100 is relatively small, assembly difficulty of the electromagnetic driving mechanism 100 is reduced, and a production cost of the electromagnetic driving mechanism 100 is further reduced.

The present disclosure further provides a camera module 200, please refer to FIG. 15, FIG. 15 is a structural schematic diagram of the camera module according to one embodiment of the present disclosure. Specifically, as shown in FIG. 15, the camera module 200 including a lens assembly 210 configured to collect light and disposed on the frame 70, the electromagnetic driving mechanism 100 as foregoing, and the imager 220 disposed on the at least one actuating assembly of the electromagnetic driving mechanism 100. The camera module 200 further includes a gyroscope (not shown in the drawings) configured to detect vibration of the lens assembly 210. Specifically, the gyroscope detects the vibration of the lens assembly 210, and then calculates a compensation distance for the lens module 210 based on a vibration angle of the lens assembly 210. Furthermore, in response to the vibration of the lens assembly 210, the at least one actuating assembly drives the imager 220 to move in a direction opposite to a vibration direction of the lens assembly 210 to achieve the image stabilization performance. In one embodiment, movement of the imager 220 is matched to an amplitude of the vibration of the lens assembly 210 to counteract the shaking caused by the vibration of the lens assembly 210, thereby achieving the image stabilization performance.

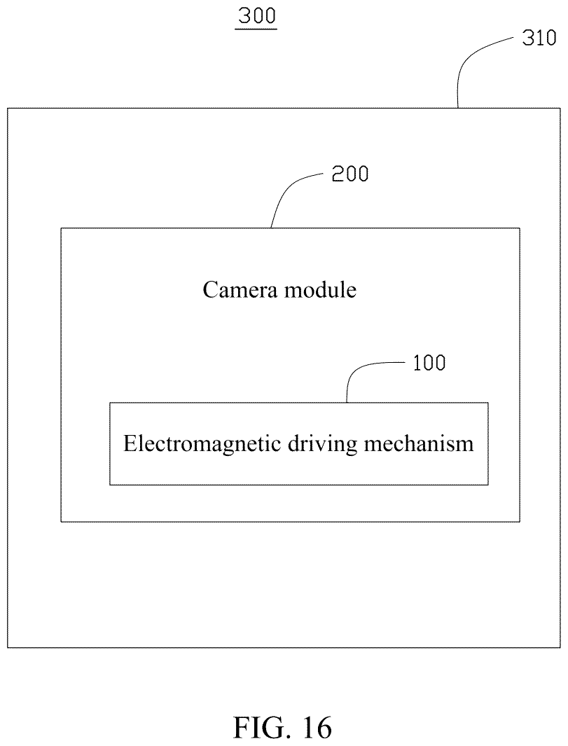

The present disclosure further provides an electronic device 300, as shown in FIG. 16, FIG. 16 is a structural schematic diagram of an electronic device according to one embodiment of the present disclosure. Specifically, as shown in FIG. 16, the present disclosure provides the electronic device 300, including a device main body 310 and the camera module 200 as foregoing. The camera module 200 is disposed on the device main body 310. The electronic device in the embodiments of the present disclosure has the same beneficial effects as the camera module in the embodiments of the present disclosure, and details are not described herein again.

The above are only preferred embodiments of the present disclosure, and are not therefore intended to limit a patent scope of the present disclosure, and any equivalent structure or equivalent process transformation, made by using the specification and the drawings of the present disclosure, directly or indirectly used in other related technical fields, are all included in the patent scope of the present disclosure.

What is claimed is:

1. An electromagnetic driving mechanism, applied to a camera module comprising an imager, comprising:
a first metal plate;
a second metal plate disposed opposite to the first metal plate;
at least one coil;
at least one magnetic element, wherein the at least one coil and the at least one magnetic element are stacked between the first metal plate and the second metal plate; and
at least one actuating assembly disposed on the first metal plate and connected to the at least one coil, wherein the at least one actuating assembly is configured to support the imager;
wherein the at least one coil is driven by an Ampere force to move with respect to the at least one magnetic element within a magnetic field of the at least one magnetic element after being energized, thereby driving the at least one actuating assembly to deform to drive the imager to move.

2. The electromagnetic driving mechanism according to claim 1, wherein the at least one actuating assembly comprises a motion control component and a flexible electrical connector;
the motion control component is connected to the at least one coil and the first metal plate, the motion control component is configured to deform and move within a plane parallel to the first metal plate and is limited from moving out of the plane;
the flexible electrical connector is connected to the motion control component;
the at least one coil is fixedly connected to two ends of the motion control component; and
the at least one coil drives the motion control component to at least partially deform to drive the imager to move.

3. The electromagnetic driving mechanism according to claim 2, wherein the flexible electrical connector comprises a wire portion main body, a first connecting portion, and a second connecting portion;
the first connecting portion is connected to a first side of the wire portion main body and is connected to the motion control component; and
the second connecting portion is connected a second side of the wire portion main body and is disposed opposite to the first connecting portion.

4. The electromagnetic driving mechanism according to claim 3, wherein the motion control component comprises two first moving portions, a second moving portion, at least one elastic portion, and a fixing portion;
the two first moving portions are respectively disposed at two ends of the wire portion main body in a length direction of the wire portion main body;
the second moving portion is connected to the first connecting portion and is configured to support the imager;
the at least one elastic portion is disposed at a periphery of the second moving portion and is connected to the first connecting portion;
the fixing portion is disposed on the at least one elastic portion and is fixedly connected to the first metal plate; and
the two first moving portions, the second moving portion, and the imager move along with the at least one coil, and the at least one elastic portion is configured to elastically deform.

5. The electromagnetic driving mechanism according to claim 4, wherein the first connecting portion is electrically connected to the imager via wire bonding.

6. The electromagnetic driving mechanism according to claim 5, wherein the first metal plate defines at least one first slot, the at least one first slot penetrates through the first metal plate in a thickness direction of the first metal plate.

7. The electromagnetic driving mechanism according to claim 6, wherein the electromagnetic driving mechanism further comprises a circuit board;
the circuit board is disposed opposite to the first metal plate and is disposed at one side of the first metal plate away from the second metal plate; and
the second connecting portion is electrically connected to the circuit board via the wire bonding.

8. The electromagnetic driving mechanism according to claim 7, wherein the first metal plate further defines at least one second slot, the at least one second slot is defined closer to an edge of the first metal plate than the at least one first slot; and
the second connecting portion is electrically connected to the circuit board through the at least one second slot via the wire bonding.

9. The electromagnetic driving mechanism according to claim 4, wherein the at least one coil spans across the flexible electrical connector and is disposed on the two first moving portions.

10. The electromagnetic driving mechanism according to claim 4, wherein the at least one elastic portion comprises a first sub-elastic portion and a second sub-elastic portion, the first sub-elastic portion is connected to the second-sub elastic portion.

11. The electromagnetic driving mechanism according to claim 10, wherein the first sub-elastic portion is bent and connected to the second sub-elastic portion.

12. The electromagnetic driving mechanism according to claim 2, wherein at least four actuating assemblies are provided, the at least four actuating assemblies comprise at least four motion control components, a plurality of magnetic elements are provided and are divided into at least two groups of magnetic elements, and at least two coils are provided.

13. The electromagnetic driving mechanism according to claim 12, wherein each of the at least two groups of magnetic elements is disposed corresponding to a corresponding one of the at least two coils; and
each of the at least two groups of magnetic elements comprises two magnets disposed side by side or a single magnet.

14. The electromagnetic driving mechanism according to claim 13, wherein first projections of each two magnets onto a plane parallel to a plane of the first metal plate are side by side, and second projections of each two magnets onto a plane perpendicular to the plane of the first metal plate completely overlap.

15. The electromagnetic driving mechanism according to claim 13, wherein on the plane parallel to the plane of the first metal plate, a first projection of each of the at least two coils falls within a first projection of a corresponding one of the at least two groups of magnetic elements; and
on the plane perpendicular to the plane of the first metal plate, a second projection of each of the at least two coils is parallel to a second projection of the corresponding one of the at least two groups of magnetic elements.

16. The electromagnetic driving mechanism according to claim 15, wherein on the plane parallel to the plane of the first metal plate, a center point of the first projection of each of the at least two coils overlaps a center point of the first projection of the corresponding one of the at least two groups of magnetic elements.

17. The electromagnetic driving mechanism according to claim 13, wherein four motion control components are provided, the four motion control components are disposed on the first metal plate, the four motion control components are centered on the imager and are respectively disposed at opposite sides of the imager.

18. The electromagnetic driving mechanism according to claim 17, wherein the four motion control components are integrally formed.

19. The electromagnetic driving mechanism according to claim 17, wherein four groups of magnetic elements are provided, the four groups of magnetic elements are disposed at a periphery of the four motion control components at intervals along a circumferential direction of the four motion control components.

20. The electromagnetic driving mechanism according to claim 17, wherein four coils are provided, the four coils are respectively connected to the four motion control components.

21. The electromagnetic driving mechanism according to claim 2, wherein the motion control component and the flexible electrical connector are integrally formed.

22. The electromagnetic driving mechanism according to claim 2, wherein a material for preparing the motion control component and/or the flexible electrical connector comprises a silicon wafer.

23. The electromagnetic driving mechanism according to claim 1, wherein the at least one magnetic element is connected to the second metal plate, the second metal plate, the at least one magnetic element, and the at least one coil are stacked in sequence; or the at least one magnetic element is connected to the first metal plate, the second metal plate, the at least one coil, and the at least one magnetic element are stacked in sequence.

24. A camera module, comprising:
a lens assembly configured to collect light;
an electromagnetic driving mechanism;
a gyroscope configured to detect vibration of the lens assembly; and
an imager disposed on at least one actuating assembly of the electromagnetic driving mechanism;
wherein the electromagnetic driving mechanism comprises:
a first metal plate;
a second metal plate disposed opposite to the first metal plate;
at least one coil;
at least one magnetic element, wherein the at least one coil and the at least one magnetic element are stacked between the first metal plate and the second metal plate; and
the at least one actuating assembly disposed on the first metal plate and connected to the at least one coil, wherein the at least one actuating assembly is configured to support the imager;
wherein the at least one coil is driven by an Ampere force to move with respect to the at least one magnetic element within a magnetic field of the at least one magnetic element after being energized, thereby driving the at least one actuating assembly to deform to drive the imager to move;
wherein in response to the vibration of the lens assembly, the at least one actuating assembly drives the imager to move in a direction opposite to a vibration direction of the lens assembly.

25. An electronic device, comprising:
a device main body; and
the camera module according to claim 24;
wherein the camera module is disposed on the device main body.
